(19) United States
(12) Patent Application Publication
(10) Pub. No.: US 2026/0302604 A1
(43) Pub. Date: Oct. 1, 2026

(54) LIQUID CRYSTAL ANTENNA ARRAY AND COMMUNICATION DEVICE

(71) Applicants: BEIJING BOE SENSOR TECHNOLOGY CO., LTD., Beijing (CN); BOE TECHNOLOGY GROUP CO., LTD., Beijing (CN)

(72) Inventors: Yiming WANG, Beijing (CN); Xiaoqiang YANG, Beijing (CN); Wei ZHAO, Beijing (CN); Lu CHEN, Beijing (CN); Mengjiao LI, Beijing (CN); Zhifeng ZHANG, Beijing (CN)

(21) Appl. No.: 18/879,454

(22) PCT Filed: Apr. 28, 2023
(86) PCT No.: PCT/CN2023/091656

§ 371 Date: Dec. 27, 2024

(51) Int. Cl. H01Q 15/24; H01Q 1/38; H01Q 1/50

(52) U.S. Cl. CPC H01Q 15/24; H01Q 1/38; H01Q 1/50

(57) ABSTRACT

A liquid crystal antenna array and a communication device. In the liquid crystal antenna array, an output end of the full-phasor adjustable phase shifter is coupled to an input end of the power division structure; the first adjustable phase shifter is coupled to a first output end of the power division structure; the first coupling structure couples an output end of the first adjustable phase shifter to the radiation patch; the second coupling structure couples, to the radiation patch, electromagnetic waves outputted by a second output end of the power division structure; the first coupling structure is orthogonal to the second coupling structure; the phase adjustment range of the first adjustable phase shifter is less than the phase adjustment range of the full-phasor adjustable phase shifter.

### TECHNICAL FIELD

Embodiments of the present disclosure relate to a liquid crystal antenna array and a communication device

### BACKGROUND

For a common beam scanning antenna, its control types can be roughly divided into discrete type and continuous type; because liquid crystal has the characteristic of continuous change of dielectric constant in a certain driving voltage range, liquid crystal antenna using liquid crystal as dielectric layer has become a research hotspot of continuous (or high bit number) beam scanning antenna.

The existing liquid crystal antenna array is usually formed by periodically arranging a plurality of liquid crystal phase shifters on a whole dielectric substrate (including an upper substrate, a liquid crystal layer and a lower substrate), so that the beam direction is controlled by using the characteristics of the liquid crystal phase shifters, and the functions of phased array, reflective array or transmissive array are realized.

On the other hand, the polarization characteristics of the antenna are defined by the spatial orientation of the electric field intensity vector of the electromagnetic wave radiated by the antenna in the maximum radiation direction. The types of polarization are divided by the trajectory of the vector end of the electric field intensity vector. The polarization characteristics of antenna can be divided into linear polarization, circular polarization and elliptical polarization. Linear polarization is divided into horizontal polarization and vertical polarization; circular polarization is divided into left-handed circular polarization and right-handed circular polarization.

In the case that the included angle between the polarized plane of electromagnetic wave radiated by antenna and the geodetic normal plane changes periodically from 0 to 360 degrees, that is to say, the magnitude of electric field is constant in magnitude and the direction changes with time, and the trajectory of the end of the electric field vector is projected as a circle on the plane perpendicular to the propagation direction, it is called circular polarization. Circular polarization can be obtained in the case that the horizontal and vertical components of the electric field have the same amplitude and the phase difference is 90 or 270 degrees. Circular polarization, if the polarization plane rotates with time and forms a right spiral relationship with the propagation direction of the electromagnetic wave, it is called right-handed circular polarization; on the other hand, if there is a left spiral relationship, it is called left-handed circular polarization.

### SUMMARY

Embodiments of the present disclosure provide a liquid crystal antenna array and a communication device. The liquid crystal antenna array can modulate the phase of the electromagnetic wave input to the antenna structure through the full phase adjustable phase shifter, so that the electromagnetic waves emitted by different antenna structures have different phases, and then the beam scanning function is realized; meanwhile, the liquid crystal antenna array can further adjust or reconstruct the polarization of the electromagnetic wave input to the antenna structure through the power division structure and the adjustable phase shifter with a relatively small area. Moreover, because the antenna structure has a relatively small area, it is beneficial to the miniaturization of the liquid crystal antenna array.

At least one embodiment of the present disclosure provides a liquid crystal antenna array, comprising a plurality of antenna structures arranged in an array, wherein each of the plurality of antenna structure comprises: a phase shifter layer, comprising a full phase adjustable phase shifter, a power division structure and at least one adjustable phase shifter; a radiation patch; and a first coupling layer, the power division structure comprises an input end, a first output end and a second output end, an output end of the full phase adjustable phase shifter is coupled with the input end of the power division structure, the at least one adjustable phase shifter comprises a first adjustable phase shifter, the first adjustable phase shifter is coupled with the first output end of the power division structure, the first coupling layer comprises a first coupling structure and a second coupling structure, the first coupling structure couples an output end of the first adjustable phase shifter with the radiation patch, and the second coupling structure couples an electromagnetic wave output from the second output end of the power division structure to the radiation patch, a first connection line between a center of the first coupling structure and a center of the radiation patch and a second connection line between a center of the second coupling structure and the center of the radiation patch are perpendicular to each other, a phase adjustment range of the first adjustable phase shifter is smaller than a phase adjustment range of the full phase adjustable phase shifter, an area of the first adjustable phase shifter is smaller than an area of the full phase adjustable phase shifter.

For example, in the liquid crystal antenna array provided by an embodiment of the present disclosure, the phase adjustment range of the first adjustable phase shifter is in a range from 0 to 90 degrees.

For example, in the liquid crystal antenna array provided by an embodiment of the present disclosure, the full phase adjustable phase shifter is configured to adjust a phase of an electromagnetic wave input to each of the plurality of antenna structure, and the power division structure and the first adjustable phase shifter are configured to adjust a polarization of the electromagnetic wave input to each of the plurality of antenna structure.

For example, in the liquid crystal antenna array provided by an embodiment of the present disclosure, in at least one of the plurality of antenna structure, the at least one adjustable phase shifter further comprises a second adjustable phase shifter, the second adjustable phase shifter is coupled with the second output end of the power division structure, and the second coupling structure couples an output end of the second adjustable phase shifter with the radiation patch, so as to couple the electromagnetic wave output from the second output end of the power division structure to the radiation patch, the phase adjustment range of the first adjustable phase shifter is smaller than the phase adjustment range of the full phase adjustable phase shifter, and the area of the first adjustable phase shifter is smaller than the area of the full phase adjustable phase shifter, a phase adjustment range of the second adjustable phase shifter is smaller than the phase adjustment range of the full phase adjustable phase shifter, and an area of the second adjustable phase shifter is smaller than the area of the full phase adjustable phase shifter.

For example, in the liquid crystal antenna array provided by an embodiment of the present disclosure, the phase adjustment range of the first adjustable phase shifter is in a range from 0 to 90 degrees, the phase adjustment range of the second adjustable phase shifter is in a range from 0 to 90 degrees.

For example, in the liquid crystal antenna array provided by an embodiment of the present disclosure, the full phase adjustable phase shifter is configured to adjust a phase of an electromagnetic wave input to each of the plurality of antenna structure, and the power division structure, the first adjustable phase shifter and the second adjustable phase shifter are configured to adjust a polarization of an electromagnetic wave input to each of the plurality of antenna structure.

For example, in the liquid crystal antenna array provided by an embodiment of the present disclosure, the phase shifter layer comprises: a first substrate; a second substrate, disposed opposite to and spaced from the first substrate; a liquid crystal layer, located between the first substrate and the second substrate; a first conductive pattern layer; and a second conductive pattern layer, the first conductive pattern layer is located at a side of the first substrate close to the liquid crystal layer, and the second conductive pattern layer is located at a side of the second substrate close to the liquid crystal layer, or, the first conductive pattern layer is located at a side of the second substrate close to the liquid crystal layer, and the second conductive pattern layer is located at a side of the first substrate close to the liquid crystal layer.

For example, in the liquid crystal antenna array provided by an embodiment of the present disclosure, the first conductive pattern comprises a first driving electrode and a second driving electrode, and the second conductive pattern comprises a first common electrode and a second common electrode; an orthographic projection of the first driving electrode on the liquid crystal layer overlaps with an orthographic projection of the first common electrode on the liquid crystal layer, so as to form the full phase adjustable phase shifter, an orthographic projection of the second driving electrode on the liquid crystal layer overlaps with an orthographic projection of the second common electrode on the liquid crystal layer, so as to form the first adjustable phase shifter.

For example, in the liquid crystal antenna array provided by an embodiment of the present disclosure, an area of the first driving electrode is larger than an area of the second driving electrode.

For example, in the liquid crystal antenna array provided by an embodiment of the present disclosure, the second conductive pattern layer further comprises a power division conductive pattern comprising a first end portion, a second end portion and an intermediate portion located between the first end portion and the second end portion; the intermediate portion is the input end of the power division structure, the first end portion is the first output end of the power division structure, and the second end portion is the second output end of the power division structure.

For example, in the liquid crystal antenna array provided by an embodiment of the present disclosure, the second conductive pattern layer further comprises a first transmission line and a second transmission line; the intermediate portion of the power division conductive pattern is coupled with the first common electrode, first end portion of the power division conductive pattern is connected with the second common electrode, the first transmission line connects the second common electrode with the first coupling structure, the second transmission line connects the second end portion of the power division conductive pattern with the second coupling structure.

For example, in the liquid crystal antenna array provided by an embodiment of the present disclosure, the first driving electrode comprises a bent portion, and the first common electrode comprises a bent portion.

For example, in the liquid crystal antenna array provided by an embodiment of the present disclosure, the first conductive pattern layer further comprises: a first driving line, connected with the first driving electrode; and a second driving line, connected with the second driving electrode.

For example, in the liquid crystal antenna array provided by an embodiment of the present disclosure, the phase shifter layer comprises: a first substrate; a second substrate, disposed opposite to and spaced from the first substrate; a liquid crystal layer, located between the first substrate and the second substrate; a first conductive pattern layer; and a second conductive pattern layer, the first conductive pattern layer is located at a side of the first substrate close to the liquid crystal layer, and the second conductive pattern layer is located at a side of the second substrate close to the liquid crystal layer, or, the first conductive pattern layer is located at a side of the second substrate close to the liquid crystal layer, and the second conductive pattern layer is located at a side of the first substrate close to the liquid crystal layer.

For example, in the liquid crystal antenna array provided by an embodiment of the present disclosure, the first conductive pattern comprises a first driving electrode, a second driving electrode and a third driving electrode, and the second conductive pattern comprises a first common electrode, a second common electrode and a third common electrode; an orthographic projection of the first driving electrode on the liquid crystal layer overlaps with an orthographic projection of the first common electrode on the liquid crystal layer, so as to form the full phase adjustable phase shifter, an orthographic projection of the second driving electrode on the liquid crystal layer overlaps with an orthographic projection of the second common electrode on the liquid crystal layer, so as to form the first adjustable phase shifter, an orthographic projection of the third driving electrode on the liquid crystal layer overlaps with an orthographic projection of the third common electrode on the liquid crystal layer, so as to form the second adjustable phase shifter.

For example, in the liquid crystal antenna array provided by an embodiment of the present disclosure, the second driving electrode and the third driving electrode are mirror symmetrical about a virtual straight line extending in an extension direction of the first driving electrode.

For example, in the liquid crystal antenna array provided by an embodiment of the present disclosure, the full phase adjustable phase shifter comprises any one of a delay linear adjustable phase shifter, a differential linear adjustable phase shifter and a resonant adjustable phase shifter, and the first adjustable phase shifter comprises any one of a delay linear adjustable phase shifter, a differential linear adjustable phase shifter and a resonant adjustable phase shifter.

For example, in the liquid crystal antenna array provided by an embodiment of the present disclosure, the first coupling structure comprises a first slot located in the first coupling layer, and the second coupling structure comprises a second slot located in the first coupling layer, or, the first coupling structure comprises a first probe passing through the first coupling layer, and the second coupling structure comprises a second probe passing through the first coupling layer.

For example, in the liquid crystal antenna array provided by an embodiment of the present disclosure, each of the plurality of antenna structure further comprises: a second coupling layer, comprising a third coupling structure; and a receiving structure; the third coupling structure couples the receiving structure with an input end of the full phase adjustable phase shifter.

For example, in the liquid crystal antenna array provided by an embodiment of the present disclosure, the third coupling structure comprises a third slot located in the second coupling layer or a third probe passing through the second coupling layer.

For example, in the liquid crystal antenna array provided by an embodiment of the present disclosure, the receiving structure comprises a receiving patch or a feed line.

For example, the liquid crystal antenna array provided by an embodiment of the present disclosure further comprises: a plurality of waveguides, arranged in one-to-one correspondence with the plurality of receiving structures of the plurality of antenna structures.

At least one embodiment of the present disclosure provides a communication device, comprising any one of the abovementioned liquid crystal antenna array.

### BRIEF DESCRIPTION OF DRAWINGS

In order to more clearly explain the technical solution of the embodiments of the present disclosure, the attached drawings of the embodiments will be briefly introduced below. Obviously, the attached drawings in the following description only relate to some embodiments of the present disclosure, and are not limited to the present disclosure.

FIG. 1 is a schematic diagram of a liquid crystal antenna array provided by an embodiment of the present disclosure;

FIG. 2 is a schematic plan view of an antenna structure in a liquid crystal antenna array according to an embodiment of the present disclosure;

FIG. 3 is a schematic sectional view of an antenna structure in a liquid crystal antenna array according to an embodiment of the present disclosure;

FIG. 4 is a schematic plan view of a first conductive pattern in a liquid crystal antenna array according to an embodiment of the present disclosure;

FIG. 5 is a schematic plan view of a second conductive pattern in a liquid crystal antenna array according to an embodiment of the present disclosure;

FIG. 6 is a schematic plan view of a radiation patch in a liquid crystal antenna array according to an embodiment of the present disclosure;

FIG. 7 is a schematic plan view of a first coupling layer in a liquid crystal antenna array according to an embodiment of the present disclosure;

FIG. 8 is a schematic plan view of a second coupling layer in a liquid crystal antenna array according to an embodiment of the present disclosure;

FIG. 9 is a schematic plan view of a receiving structure in a liquid crystal antenna array according to an embodiment of the present disclosure;

FIG. 10 is a schematic plan view of an antenna structure in another liquid crystal antenna array provided by an embodiment of the present disclosure;

FIG. 11 is a schematic sectional view of an antenna structure in another liquid crystal antenna array provided by an embodiment of the present disclosure;

FIG. 12 is a schematic plan view of a first conductive pattern in another liquid crystal antenna array according to an embodiment of the present disclosure;

FIG. 13 is a schematic plan view of a second conductive pattern in another liquid crystal antenna array according to an embodiment of the present disclosure;

FIG. 14 is a schematic plan view of a radiation patch in another liquid crystal antenna array according to an embodiment of the present disclosure;

FIG. 15 is a schematic plan view of a first coupling layer in another liquid crystal antenna array according to an embodiment of the present disclosure;

FIG. 16 is a schematic plan view of a second coupling layer in another liquid crystal antenna array according to an embodiment of the present disclosure;

FIG. 17 is a schematic plan view of a receiving structure in another liquid crystal antenna array according to an embodiment of the present disclosure;

FIG. 18 is a schematic plan view of a first conductive pattern in another liquid crystal antenna array according to an embodiment of the present disclosure;

FIG. 19 is a schematic plan view of a second conductive pattern in another liquid crystal antenna array according to an embodiment of the present disclosure;

FIG. 20 is a schematic plan view of a radiation patch in another liquid crystal antenna array according to an embodiment of the present disclosure;

FIG. 21 is a schematic plan view of a first coupling layer in another liquid crystal antenna array according to an embodiment of the present disclosure;

FIG. 22 is a schematic plan view of a second coupling layer in another liquid crystal antenna array according to an embodiment of the present disclosure;

FIG. 23 is a schematic plan view of a receiving structure in another liquid crystal antenna array according to an embodiment of the present disclosure;

FIG. 24A is a schematic diagram of a coupling mode between a differential linear adjustable phase shifter and a coupling slot according to an embodiment of the present disclosure;

FIG. 24B is a schematic diagram of a coupling mode between another differential linear adjustable phase shifter and a coupling slot provided by an embodiment of the present disclosure;

FIG. 24C is a schematic diagram of a coupling mode between a differential linear adjustable phase shifter and a probe provided by an embodiment of the present disclosure;

FIG. 25A is a schematic diagram of a coupling mode between a delay linear adjustable phase shifter and a coupling slot according to an embodiment of the present disclosure;

FIG. 25B is a schematic diagram of a coupling mode between another delay linear adjustable phase shifter and a probe provided by an embodiment of the present disclosure;

FIG. 26A is a schematic diagram of a coupling mode between a resonant adjustable phase shifter and a coupling slot according to an embodiment of the present disclosure;

FIG. 26B is a schematic diagram of a coupling mode between another resonant adjustable phase shifter and a probe provided by an embodiment of the present disclosure;

FIG. 27A is a schematic diagram of a coupling mode between a differential linear adjustable phase shifter and a power division structure according to an embodiment of the present disclosure;

FIG. 27B is a schematic diagram of a coupling mode between another differential linear adjustable phase shifter and a power division structure provided by an embodiment of the present disclosure;

FIG. 27C is a schematic diagram of a coupling mode between a delay linear adjustable phase shifter and a power division structure according to an embodiment of the present disclosure;

FIG. 27D is a schematic diagram of a coupling mode between a resonant adjustable phase shifter and a power division structure according to an embodiment of the present disclosure;

FIG. 28 is a schematic diagram of another liquid crystal antenna array provided by an embodiment of the present disclosure;

FIG. 29 is a schematic diagram of another liquid crystal antenna array provided by an embodiment of the present disclosure; and

FIG. 30 is a schematic diagram of a communication device provided by an embodiment of the present disclosure.

### DETAILED DESCRIPTION

In order to make the purpose, technical solution and advantages of the embodiment of the disclosure clearer, the technical solution of the embodiment of the disclosure will be described clearly and completely with the attached drawings. Obviously, the described embodiment is a part of the embodiment of the present disclosure, not the whole embodiment. Based on the described embodiments of the present disclosure, all other embodiments obtained by ordinary people in the field without creative labor belong to the scope of protection of the present disclosure.

Unless otherwise defined, technical terms or scientific terms used in the present disclosure shall have their ordinary meanings as understood by people with ordinary skills in the field to which the present disclosure belongs. The terms “first”, “second” and the like used in the present disclosure do not indicate any order, quantity or importance, but are only used to distinguish different components. Similar words such as “including” or “containing” mean that the elements or objects appearing before the word cover the elements or objects listed after the word and their equivalents, without excluding other elements or objects. Similar words such as “connected” or “connected” are not limited to physical or mechanical connection, but may include electrical connection, whether direct or indirect.

With the continuous development of communication technology, the more application scenarios of wireless communication; some communication devices need to receive or send linear polarization signals, some communication devices need to receive or send left-handed circular polarization signals, and some communication devices need to receive or send right-handed circular polarization signals. Therefore, the antenna needs to have polarization reconstruction function to meet different scenarios requiring different polarization characteristics.

On the other hand, the inventor(s) of the present disclosure noticed that under the projection array or phased array architecture, if polarization adjustment or polarization reconstruction is carried out by two groups of full phase adjustable phase shifters, the area occupied by a single antenna structure or antenna element is too large, and considering the limitation of the large-angle scanning performance of the antenna on the size of the antenna element, the layout in the antenna element will become extremely difficult or even not feasible.

With this regard, embodiments of the present disclosure provide a liquid crystal antenna array. The liquid crystal antenna array includes a plurality of antenna structures arranged in an array; each of the plurality of antenna structures includes a phase shifter layer, a radiation patch and a first coupling layer; the phase shifter layer includes a full phase adjustable phase shifter, a power division structure and at least one adjustable phase shifter; the power division structure includes an input end, a first output end and a second output end, an output end of the full phase adjustable phase shifter is coupled with the input end of the power division structure, the at least one adjustable phase shifter includes a first adjustable phase shifter coupled with the first output end of the power division structure, and the first coupling layer includes a first coupling structure and a second coupling structure. The first coupling structure couples an output end of the first adjustable phase shifter with the radiation patch, and the second coupling structure couples the electromagnetic wave output from the second output end of the power division structure to the radiation patch. A first connection line between a center of the first coupling structure and a center of the radiation patch and a second connection line between a center of the second coupling structure and the center of the radiation patch are perpendicular to each other, and a phase adjustment range of the first adjustable phase shifter is smaller than a phase adjustment range of the full phase adjustable phase shifter, an area of the first adjustable phase shifter is smaller than an area of the full phase adjustable phase shifter. Therefore, the liquid crystal antenna array can modulate the phase of the electromagnetic wave input to the antenna structure through the full phase adjustable phase shifter, so that the electromagnetic waves emitted by different antenna structures have different phases, thereby realizing the beam scanning function; meanwhile, the liquid crystal antenna array can further adjust or reconstruct the polarization of the electromagnetic wave input to the antenna structure through the power division structure and the first adjustable phase shifter with a relatively small area, so that the beam scanning with polarization reconfigurable can be realized. Moreover, because the antenna structure has a relatively small area, it is beneficial to the miniaturization of the liquid crystal antenna array.

The embodiment of the present disclosure further provides a communication device, which includes the above-mentioned liquid crystal antenna array. Therefore, the communication device can perform beam scanning through the liquid crystal antenna array, and can also perform polarization adjustment or polarization reconstruction through the liquid crystal antenna array, so as to meet different scenes requiring different polarization characteristics, thus having high communication performance. Moreover, because the liquid crystal antenna array is relatively small in size, it is beneficial to miniaturization of the communication device.

Hereinafter, the liquid crystal antenna array and the communication device provided by the embodiments of the present disclosure will be described in detail with reference to the accompanying drawings.

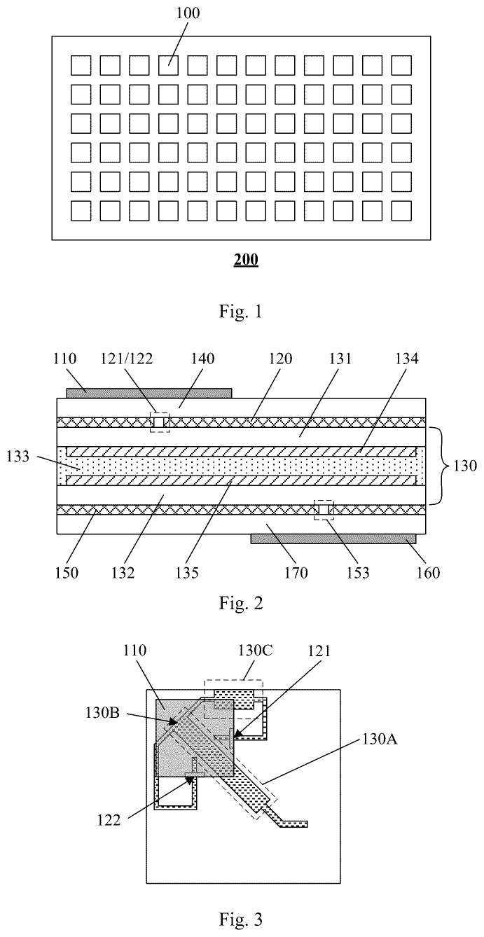

An embodiment of the present disclosure provides a liquid crystal antenna array. FIG. 1 is a schematic diagram of a liquid crystal antenna array provided by an embodiment of the present disclosure; FIG. 2 is a schematic plan view of an antenna structure in a liquid crystal antenna array according to an embodiment of the present disclosure; FIG. 3 is a schematic sectional view of an antenna structure in a liquid crystal antenna array according to an embodiment of the present disclosure.

As illustrated by FIG. 1, the liquid crystal antenna array 200 includes a plurality of antenna structures 100 arranged in an array. For example, the plurality of antenna structures 100 may be arranged in an array along a first direction and a second direction. Of course, the embodiments of the present disclosure include but are not limited to an array arrangement illustrated by FIG. 1, and the array arrangement of the plurality of antenna structures can be set according to actual requirements. It should be noted that the above antenna structure can also be called an antenna unit, which can independently emit, phase modulate and polarize the electromagnetic wave.

As illustrated by FIGS. 2 and 3, each of the plurality of antenna structures 100 includes a phase shifter layer 130, a radiation patch 110 and a first coupling layer 120. The phase shifter layer 130 includes a full phase adjustable phase shifter 130A, a power division structure 130B and at least one adjustable phase shifter. The power division structure 130B includes an input end, a first output end and a second output end, and an output end of the full phase adjustable phase shifter 130A is coupled with the input end of the power division structure 130B. The at least one adjustable phase shifter includes a first adjustable phase shifter 130C coupled with the first output end of the power division structure 130B, and the first coupling layer 120 includes a first coupling structure 121 and a second coupling structure 122. The first coupling structure 121 couples an output end of the first adjustable phase shifter 130C with the radiation patch 110, and the second coupling structure 122 couples the electromagnetic wave output from the second output end of the power division structure 130B to the radiation patch 110. A first connection line between a center of the first coupling structure 121 and a center of the radiation patch 110 and a second connection line between a center of the second coupling structure 122 and the center of the radiation patch 110 are perpendicular to each other. A phase adjustment range of the first adjustable phase shifter 130C is smaller than a phase adjustment range of the full phase adjustable phase shifter 130A, and an area of the first adjustable phase shifter 130C is smaller than an area of the full phase adjustable phase shifter 130A.

It should be noted that the phase adjustment range of the liquid crystal phase shifter is usually related to the area occupied by the liquid crystal phase shifter, so the first adjustable phase shifter with relatively small phase adjustment range also has a relatively small area; in addition, the above-mentioned full phase adjustable phase shifter refers to an adjustable phase shifter with the phase adjustment range from 0 to 360 degrees. It is worth noting that the coupling in the embodiment of the present disclosure includes the case of coupling through direct connection.

In the liquid crystal antenna array provided by the embodiment of the present disclosure, the phase of the electromagnetic wave input to the antenna structure can be adjusted by the full phase adjustable phase shifter, so that the electromagnetic waves emitted by different antenna structures can have different phases, and then the beam scanning function can be realized by using the principles of constructive interference and destructive interference. In this case, because the output end of the full phase adjustable phase shifter is coupled with the input end of the power division structure, the first adjustable phase shifter is coupled with the first output end of the power division structure, the first coupling structure couples the output end of the first adjustable phase shifter with the radiation patch, and the second coupling structure couples the electromagnetic wave output from the second output end of the power division structure to the radiation patch. The first connection line between the center of the first coupling structure and the center of the radiation patch and the second connection line between the center of the second coupling structure and the center of the radiation patch are perpendicular to each other, so the power division structure can divide the electromagnetic wave signal modulated by the full phase adjustable phase shifter into two electromagnetic wave signals, which are respectively coupled to the radiation patch through the first coupling structure and the second coupling structure and polarized in the radiation patch; in this process, because the first adjustable phase shifter is coupled with the first output end of the power division structure, the first coupling structure couples the output end of the first adjustable phase shifter with the radiation patch, and the first adjustable phase shifter can phase modulate the electromagnetic wave signal output from the first output end of the power division structure, so that the electromagnetic wave signal has a phase difference with the electromagnetic wave signal output from the first output end of the power division structure, thereby forming different types of polarized waves, such as circularly polarized waves or linearly polarized waves. Therefore, the liquid crystal antenna array can simultaneously adjust or reconstruct the polarization of the electromagnetic wave input to the antenna structure through the power division structure and the first adjustable phase shifter with the relatively small area. On the other hand, because the area of the first adjustable phase shifter is smaller than the area of the full phase adjustable phase shifter, the layout can be facilitated, so that the antenna structure has a relatively small area, which is beneficial to the miniaturization of the liquid crystal antenna array.

It should be noted that the above circularly polarized wave also include a perfect circularly polarized wave and an elliptically polarized wave; in the case that an axial ratio of the circularly polarized wave is 1, it is the perfect circularly polarized wave; in the case that the axial ratio of circularly polarized wave is greater than 1, it is the elliptically polarized wave. In addition, the first connection line between the center of the first coupling structure and the center of the radiation patch and the second connection line between the center of the second coupling structure and the center of the radiation patch are perpendicular to each other, which can be called that the first coupling structure and the second coupling structure are orthogonal.

For example, in the case that the first adjustable phase shifter can phase modulate the electromagnetic wave signal output by the first output end of the power division structure, so that the electromagnetic wave signal has the phase difference with the electromagnetic wave signal output by the second output end of the power division structure, for example, the phase difference is 90 degrees, the circularly polarized wave can be formed in the radiation patch and transmitted through the radiation patch. It should be noted that because only the first adjustable phase shifter is provided, the above circularly polarized wave includes one of the left-handed circularly polarized wave and the right-handed circularly polarized wave.

For example, in the case that the first adjustable phase shifter can phase modulate the electromagnetic wave signal output by the first output end of the power division structure, so that the electromagnetic wave signal has the phase difference with the electromagnetic wave signal output by the second output end of the power division structure, for example, the phase difference is 0 degree, the linearly polarized wave can be formed in the radiation patch and transmitted through the radiation patch.

For example, in the case that the first adjustable phase shifter can phase modulate the electromagnetic wave signal output by the first output end of the power division structure, so that the electromagnetic wave signal has the phase difference with the electromagnetic wave signal output by the second output end of the power division structure, for example, the phase difference is greater than 0 degree and less than 90 degrees, so that the elliptically polarized wave can be formed in the radiation patch and transmitted through the radiation patch.

In some examples, the phase adjustment range of the first adjustable phase shifter 130C is in a range from 0 to 90 degrees. Therefore, the liquid crystal antenna array can realize that the electromagnetic wave signal output by the first output end of the power division structure and the electromagnetic wave signal output by the second output end of the power division structure have the phase difference of at most 90 degrees, so as to meet the requirement of forming the circularly polarized wave, and the liquid crystal antenna array also has a size as small as possible, further enabling the antenna structure to have the relatively small area, which is beneficial to miniaturization of the liquid crystal antenna array.

In some examples, the full phase adjustable phase shifter is configured to adjust the phase of the electromagnetic wave input to the antenna structure, and the power division structure and the first adjustable phase shifter are configured to adjust the polarization of the electromagnetic wave input to the antenna structure. Of course, the embodiment of the present disclosure includes but is not limited thereto, and a second adjustable phase shifter can be correspondingly arranged at the second output end of the power division structure to adjust the polarization of the electromagnetic wave input to the antenna structure together with the first adjustable phase shifter.

In some examples, as illustrated by FIGS. 2 and 3, the phase shifter layer 130 includes a first substrate 131, a second substrate 132, a liquid crystal layer 133, a first conductive pattern layer 134 and a second conductive pattern layer 135; the second substrate 132 is disposed opposite to and spaced from the first substrate 131, and the liquid crystal layer 133 is located between the first substrate 131 and the second substrate 132. The first conductive pattern layer 134 is located at a side of the first substrate 131 close to the liquid crystal layer 133, and the second conductive pattern layer 135 is located at a side of the second substrate 132 close to the liquid crystal layer 133. In another example, the first conductive pattern layer can also be located at a side of the second substrate close to the liquid crystal layer, and the second conductive pattern layer is located at a side of the first substrate close to the liquid crystal layer; that is to say, the positions of the first conductive pattern layer and the second conductive pattern layer can be interchanged.

In some examples, materials of the first substrate 131 and the second substrate 132 may include at least one selected from the group consisting of glass, resin, plastic, ceramics and a circuit board. Of course, the embodiments of the present disclosure include but are not limited thereto, and the first substrate and the second substrate can also be made of other suitable materials.

In some examples, planar shapes of the first substrate 131 and the second substrate 132 may be rectangular. Of course, the embodiments of the present disclosure include but are not limited thereto, and the planar shapes of the first substrate and the second substrate can also be other suitable shapes.

In some examples, materials of the first conductive pattern layer 134 and the second conductive pattern layer 135 include metals such as copper, aluminum, gold, silver or their alloys. Of course, the embodiments of the present disclosure include but are not limited thereto, and the materials of the first conductive pattern layer and the second conductive pattern layer can also be conductive nonmetallic materials, such as conductive metal oxides.

In some examples, a thickness of the liquid crystal layer 133 is greater than twice a thickness of the first conductive pattern layer 134 or twice a thickness of the second conductive pattern layer 135, so that the full phase adjustable phase shifter 130A and the first adjustable phase shifter 130C have better performance.

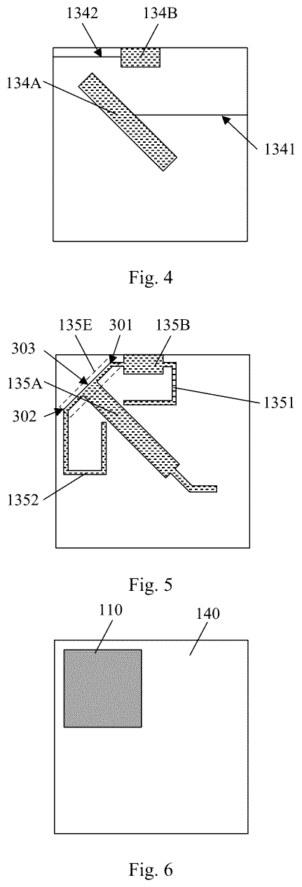

FIG. 4 is a schematic plan view of a first conductive pattern in a liquid crystal antenna array according to an embodiment of the present disclosure; FIG. 5 is a schematic plan view of a second conductive pattern in a liquid crystal antenna array according to an embodiment of the present disclosure.

In some examples, as illustrated by FIGS. 4 and 5, the first conductive pattern 134 includes a first driving electrode 134A and a second driving electrode 134B, and the second conductive pattern 135 includes a first common electrode 135A and a second common electrode 135B; an orthographic projection of the first driving electrode 134A on the liquid crystal layer 133 overlaps with an orthographic projection of the first common electrode 135A on the liquid crystal layer 133, so that the first driving electrode 134A, the first common electrode 135A, and the liquid crystal layer between the first driving electrode 134A and the first common electrode 135A can form the full phase adjustable phase shifter 130A, and a magnitude of the phase modulated by the full phase adjustable phase shifter 130A can be controlled by controlling an electric signal of the first driving electrode 134A. An orthographic projection of the second driving electrode 134B on the liquid crystal layer 133 overlaps with an orthographic projection of the second common electrode 135B on the liquid crystal layer 133, so that the second driving electrode 134B, the second common electrode 135B, and the liquid crystal layer between the second driving electrode 134B and the second common electrode 135B can form the first adjustable phase shifter 130C, and a magnitude of the phase modulated by the first adjustable phase shifter 130C can be controlled by controlling an electric signal of the second driving electrode 134B.

In some examples, the liquid crystal layer between the first driving electrode and the first common electrode and the liquid crystal layer between the second driving electrode and the second common electrode may be separated from each other by barrier structures, so that different liquid crystal materials may be used as needed.

In some examples, as illustrated by FIG. 4, the first conductive pattern layer 134 further includes a first driving line 1341 and a second driving line 1342; the first driving line 1341 is connected with the first driving electrode 134A, and the second driving line 1342 is connected with the second driving electrode 134B. Therefore, driving signals can be respectively applied to the first driving electrode and the second driving electrode through the first driving line and the second driving line, so as to respectively control a phase shift amount of the full phase adjustable phase shifter 130A and a phase shift amount of the first adjustable phase shifter 130C.

In some examples, as illustrated by FIG. 4, an area of the first driving electrode 134A is larger than an area of the second driving electrode 134B, so that an overall area of the first conductive pattern layer can be reduced, which is beneficial to miniaturization of the liquid crystal antenna array.

In some examples, as illustrated by FIG. 5, the second conductive pattern layer 135 further includes a power division conductive pattern 135E including a first end portion 301, a second end portion 302 and an intermediate portion 303 located between the first end portion 301 and the second end portion 302; the intermediate portion 303 can be used as the input end of the power division structure 130B, so as to be coupled with the output end of the full phase adjustable phase shifter 130A. The first end portion 301 is the first output end of the power division structure 130B, and the second end portion 302 is the second output end of the power division structure 130B.

In some examples, as illustrated by FIGS. 3 and 5, the second conductive pattern layer 135 further includes a first transmission line 1351 and a second transmission line 1352; the intermediate portion 303 of the power division conductive pattern 135E is coupled with the first common electrode 135A, so as to realize the coupling with the output end of the full phase adjustable phase shifter 130A; first end portion 301 of the power division conductive pattern 135E is connected with the second common electrode 135B, so that the first output end of the power division structure 135 is coupled with the first adjustable phase shifter 130C. The first transmission line 1351 connects the second common electrode 135B with the first coupling structure 121, thereby connecting the output end of the first adjustable phase shifter 130C with the first coupling structure 121; the second transmission line 1352 connects the second end portion of the power division conductive pattern 135E with the second coupling structure 122, that is to say, the second transmission line 1352 directly connects the second end portion of the power division conductive pattern 135E with the second coupling structure 122, thereby coupling with the radiation patch 110.

In some examples, as illustrated by FIGS. 3 and 5, an orthographic projection of the first coupling structure 121 on a plane where the second conductive pattern layer 135 is located and an orthographic projection of the second coupling structure 122 on the plane where the second conductive pattern layer 135 is located are mirror symmetric about a virtual straight line extending in an extension direction of the first common electrode 135A. Because the first transmission line 1351 is connected with the first coupling structure 121 and the second transmission line 1352 is connected with the second coupling structure 122, an end of the first transmission line 1351 and an end of the second transmission line 1352 are mirror symmetrical with respect to the virtual straight line extending in the extension direction of the first common electrode 135A. Therefore, the antenna structure in the liquid crystal antenna array has higher symmetry, so as to having better performance.

In some examples, as illustrated by FIG. 5, the second common electrode 135B is located at an upper right side of the first common electrode 135A, but embodiments of the present disclosure include but are not limited thereto, and the second common electrode may also be located at a lower left side of the first common electrode. That is to say, a position of the part composed of the first common electrode and the first transmission line and a position of the second transmission line can be interchanged.

It is worth noting that although the first conductive pattern layer 134 illustrated by FIG. 4 only includes the first driving electrode 134A, the second driving electrode 134B, the first driving line 1341 and the second driving line 1342, the embodiment of the present disclosure includes but is not limited thereto, and other conductive structures may be provided in the first conductive pattern layer as long as independent driving of the first driving electrode and the second driving electrode is not affected.

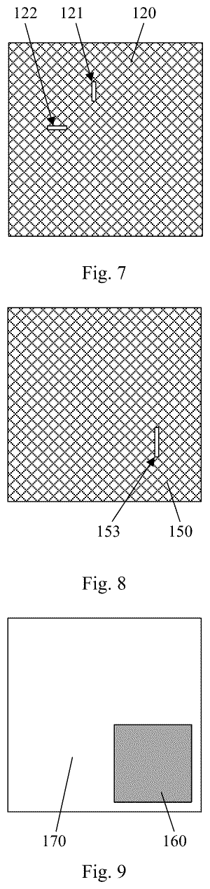

FIG. 6 is a schematic plan view of a radiation patch in a liquid crystal antenna array according to an embodiment of the present disclosure; FIG. 7 is a schematic plan view of a first coupling layer in a liquid crystal antenna array according to an embodiment of the present disclosure. It should be noted that FIG. 6 not only shows the radiation patch, but also shows a third substrate between the radiation patch and the first coupling layer. The third substrate can be used to carry the radiation patch and can also be used to insulating the first coupling layer and the radiation patch from each other.

In some examples, as illustrated by FIGS. 6 and 7, the radiation patch 110 is disposed on the third substrate 140, and the third substrate 130 may be disposed between the radiation patch 110 and the first coupling layer 120 (see FIG. 3).

In some examples, a material of the third substrate 140 may include at least one selected from the group consisting of glass, resin, plastic, ceramics and a circuit board. Of course, the embodiments of the present disclosure include but are not limited thereto, and the third substrate can also be made of other suitable materials.

In some examples, as illustrated by FIG. 6, in order to ensure the polarization function, a planar shape of the radiation patch 110 may adopt a centrally symmetric shape. For example, the shape of the radiation patch 110 is a square with central symmetry. Of course, the embodiments of the present disclosure include but are not limited thereto, and the shape of the radiation patch can also adopt other shapes with central symmetry, such as a circle or a pixel surface. It should be noted that the above-mentioned pixel surface is a square whole composed of a plurality of square arrays or a circular whole composed of a plurality of circular arrays.

In some examples, as illustrated by FIG. 7, the first coupling layer 120 may be a conductive layer; the first coupling structure 121 includes a first slot 121 located in the first coupling layer 120, and the second coupling structure 122 includes a second slot 122 located in the first coupling layer 120. Therefore, the first coupling structure 121 can couple the output end of the first adjustable phase shifter 130C with the radiation patch 110, and the second coupling structure 122 can couple the electromagnetic wave output from the second output end of the power division structure 130B with the radiation patch 110. It should be noted that in the case that both the first coupling structure and the second coupling structure are slots, the first coupling structure connected with other components means that the slot is connected with other components, or a space surrounded by the slot is connected with other components, or the slot overlaps with other components, and there is no other structure between them.

In some examples, as illustrated by FIG. 7, planar shapes of the first slot 121 and the second slot 122 are elongated shapes, but the embodiment of the present disclosure includes but is not limited thereto, and the planar shapes of the first slot 121 and the second slot 122 may also be I-shaped.

In some examples, as illustrated by FIGS. 6 and 7, a first connection line between a center of the first slot 121 and a center of the radiation patch 110 and a second connection line between a center of the second slot 122 and the center of the radiation patch 110 are perpendicular to each other; an extension direction of the first slot 121 and an extension direction of the second slot 122 are perpendicular to each other.

In some examples, as illustrated by FIGS. 2 and 3, each antenna structure 100 further includes a second coupling layer 150 and a receiving structure 160; the second coupling layer 150 includes a third coupling structure 153; the third coupling structure 153 couples the receiving structure 160 with an input end of the full phase adjustable phase shifter 130A, so that each antenna structure can receive an electromagnetic wave signal and input the electromagnetic wave signal to the full phase adjustable phase shifter 130A.

In some examples, as illustrated by FIGS. 2 and 3, each antenna structure 100 further includes a fourth substrate 170 located between the second coupling layer 150 and the receiving structure 160; the fourth substrate 170 can be used to carry the receiving structure and can also be used to insulate the second coupling layer and the receiving structure from each other.

In some examples, a material of the fourth substrate 170 may include at least one selected from the group consisting of glass, resin, plastic, ceramics and a circuit board. Of course, the embodiments of the present disclosure include but are not limited thereto, and the fourth substrate can also be made of other suitable materials.

FIG. 8 is a schematic plan view of a second coupling layer in a liquid crystal antenna array according to an embodiment of the present disclosure; FIG. 9 is a schematic plan view of a receiving structure in a liquid crystal antenna array according to an embodiment of the present disclosure.

In some examples, as illustrated by FIG. 8, the third coupling layer 150 is a conductive layer; the third coupling structure 153 includes a third slot 153 located in the second coupling layer 150, so that the third coupling structure 153 can couple the receiving structure with the input end of the full phase adjustable phase shifter.

In some examples, as illustrated by FIG. 8, a planar shape of the third slot 153 is an elongated shape, but the embodiment of the present disclosure includes but is not limited thereto, and the planar shape of the third slot 153 may also be I-shaped.

In some examples, as illustrated by FIG. 9, the receiving structure 160 is a receiving patch, and its planar shape is a square with central symmetry. Of course, the embodiments of the present disclosure include but are not limited thereto, and the receiving patch can also be a circle or pixel surface with central symmetry.

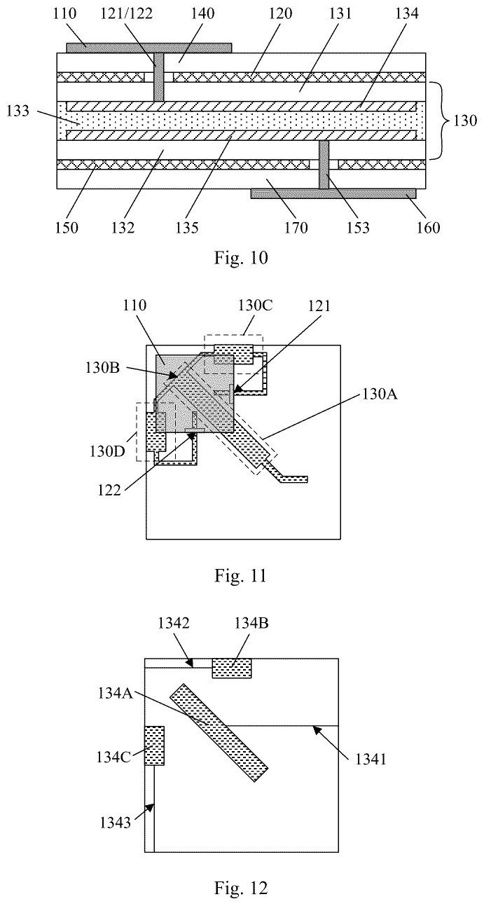

FIG. 10 is a schematic plan view of an antenna structure in another liquid crystal antenna array provided by an embodiment of the present disclosure; FIG. 11 is a schematic sectional view of an antenna structure in another liquid crystal antenna array provided by an embodiment of the present disclosure.

As illustrated by FIGS. 10 and 11, each antenna structure 100 includes a phase shifter layer 130, a radiation patch 110 and a first coupling layer 120. In at least one antenna structure 100, the phase shifter layer 130 includes a full phase adjustable phase shifter 130A, a power division structure 130B and at least one adjustable phase shifter; the at least one adjustable phase shifter includes a first adjustable phase shifter 130C and a second adjustable phase shifter 130D; the power division structure 130B includes an input end, a first output end and a second output end, and an output end of the full phase adjustable phase shifter 130A is coupled with the input end of the power division structure 130B; the first adjustable phase shifter 130C is coupled with the first output end of the power division structure 130B, and the first coupling layer 120 includes a first coupling structure 121 and a second coupling structure 122, and the first coupling structure 121 couples the output end of the first adjustable phase shifter 130C with the radiation patch 110. The second adjustable phase shifter 130D is coupled with the second output end of the power division structure 130B, and the second coupling structure 122 couples the output end of the second adjustable phase shifter 130D with the radiation patch 110, so as to couple the electromagnetic wave output from the second output end of the power division structure 130B to the radiation patch 110. A first connection line between a center of the first coupling structure 121 and a center of the radiation patch 110 and a second connection line between a center of the second coupling structure 122 and the center of the radiation patch 110 are perpendicular to each other, and a phase adjustment range of the first adjustable phase shifter 130C is smaller than a phase adjustment range of the full phase adjustable phase shifter 130A, and an area of the first adjustable phase shifter 130C is smaller than an area of the full phase adjustable phase shifter 130A, a phase adjustment range of the second adjustable phase shifter 130D is smaller than the phase adjustment range of the full phase adjustable phase shifter 130A, and an area of the second adjustable phase shifter 130D is smaller than the area of the full phase adjustable phase shifter 130A. It should be noted that the phase adjustment range of the liquid crystal phase shifter is usually related to the area occupied by the liquid crystal phase shifter, so the first adjustable phase shifter and the second adjustable phase shifter with relatively small phase adjustment range also have relatively small areas; in addition, the above-mentioned full phase adjustable phase shifter refers to an adjustable phase shifter with the phase adjustment range from 0 to 360 degrees.

In the liquid crystal antenna array provided by the embodiment of the present disclosure, the phase of the electromagnetic wave input to the antenna structure can be adjusted by the full phase adjustable phase shifter, so that the electromagnetic waves emitted by different antenna structures can have different phases, and then the beam scanning function can be realized by using the principles of constructive interference and destructive interference. In this case, because the output end of the full phase adjustable phase shifter is coupled with the input end of the power division structure, the first adjustable phase shifter is coupled with the first output end of the power division structure, the first coupling structure couples the output end of the first adjustable phase shifter with the radiation patch, the second adjustable phase shifter is coupled with the second output end of the power division structure, and the second coupling structure couples the output end of the second adjustable phase shifter with the radiation patch, the first connection line between the center of the first coupling structure and the center of the radiation patch and the second connection line between the center of the second coupling structure and the center of the radiation patch are perpendicular to each other, so the power division structure can divide the electromagnetic wave signal modulated by the full phase adjustable phase shifter into two electromagnetic wave signals, which are respectively coupled to the radiation patch through the first coupling structure and the second coupling structure and polarized in the radiation patch; in this process, because the first adjustable phase shifter can phase modulate the electromagnetic wave signal output from the first output end of the power division structure, and the second adjustable phase shifter can phase modulate the electromagnetic wave signal output from the second output end of the power division structure, so that two electromagnetic wave signals output by the first output end and the second output end of the power division structure have a phase difference, thereby different types of polarized waves can be formed, such as circularly polarized waves or linearly polarized waves. Therefore, the liquid crystal antenna array can simultaneously adjust or reconstruct the polarization of the electromagnetic wave input to the antenna structure through the power division structure and the first adjustable phase shifter and the second adjustable phase shifter with the relatively small areas, so as to realize fully polarized reconfigurable beam scanning. On the other hand, because the area of the first adjustable phase shifter is smaller than the area of the full phase adjustable phase shifter, the layout can be facilitated, so that the antenna structure has a relatively small area, which is beneficial to the miniaturization of the liquid crystal antenna array. On the other hand, because the areas of the first adjustable phase shifter and the second adjustable phase shifter are smaller than the area of the full phase adjustable phase shifter, the layout can be facilitated, so that the antenna structure has a relatively small area, which is beneficial to the miniaturization of the liquid crystal antenna array. It should be noted that the above circularly polarized wave also include a perfect circularly polarized wave and an elliptically polarized wave; in the case that an axial ratio of the circularly polarized wave is 1, it is the perfect circularly polarized wave; in the case that the axial ratio of circularly polarized wave is greater than 1, it is the elliptically polarized wave.

For example, in the case that the first adjustable phase shifter can phase modulate the electromagnetic wave signal output by the first output end of the power division structure and the second adjustable phase shifter can phase modulate the electromagnetic wave signal output by the second output end of the power division structure, so that the two electromagnetic wave signals output by the first output end and the second output end of the power division structure have a phase difference, for example, the phase difference is +90 degrees or −90 degrees, the circularly polarized wave can be formed in the radiation patch and transmitted through the radiation patch. It should be noted that because the second adjustable phase shifter is arranged, the two electromagnetic wave signals output by the first output end and the second output end of the power division structure can form a left-handed circularly polarized wave and a right-handed circularly polarized wave, that is to say, the liquid crystal antenna array can realize fully polarized type reconfigurable beam scanning.

For example, in the case that the first adjustable phase shifter can phase modulate the electromagnetic wave signal output by the first output end of the power division structure and the second adjustable phase shifter can phase modulate the electromagnetic wave signal output by the second output end of the power division structure, so that the two electromagnetic wave signals output by the first output end and the second output end of the power division structure have the phase difference, for example, the phase difference is 0 degree, the linearly polarized wave can be formed in the radiation patch and transmitted through the radiation patch.

For example, in the case that the first adjustable phase shifter can phase modulate the electromagnetic wave signal output by the first output end of the power division structure and the second adjustable phase shifter can phase modulate the electromagnetic wave signal output by the second output end of the power division structure, so that the two electromagnetic wave signals output by the first output end and the second output end of the power division structure have the phase difference, for example, the phase difference is greater than −90 degrees and less than 90 degrees, the elliptically polarized wave can be formed in the radiation patch and transmitted through the radiation patch.

In some examples, the phase adjustment range of the first adjustable phase shifter 130C is in a range from 0 to 90 degrees, the phase adjustment range of the second adjustable phase shifter 130D is in a range from 0 to 90 degrees. Therefore, the liquid crystal antenna array can realize that the two electromagnetic wave signals output by the first output end and the second output end of the power division structure have the phase difference of ±90 degrees, so as to meet the requirement of forming the circularly polarized wave, and the liquid crystal antenna array also has a size as small as possible, further enabling the antenna structure to have the relatively small area, which is beneficial to miniaturization of the liquid crystal antenna array.

In some examples, the full phase adjustable phase shifter is configured to adjust the phase of the electromagnetic wave input to the antenna structure, and the power division structure, the first adjustable phase shifter and the second adjustable phase shifter are configured to adjust or reconstruct the polarization (type) of the electromagnetic wave input to the antenna structure.

In some examples, as illustrated by FIGS. 10 and 11, the phase shifter layer 130 includes a first substrate 131, a second substrate 132, a liquid crystal layer 133, a first conductive pattern layer 134 and a second conductive pattern layer 135; the second substrate 132 is disposed opposite to and spaced from the first substrate 131, and the liquid crystal layer 133 is located between the first substrate 131 and the second substrate 132. The first conductive pattern layer 134 is located at a side of the first substrate 131 close to the liquid crystal layer 133, and the second conductive pattern layer 135 is located at a side of the second substrate 132 close to the liquid crystal layer 133. In another example, the first conductive pattern layer can also be located at a side of the second substrate close to the liquid crystal layer, and the second conductive pattern layer is located at a side of the first substrate close to the liquid crystal layer; that is to say, the positions of the first conductive pattern layer and the second conductive pattern layer can be interchanged.

In some examples, materials of the first substrate 131 and the second substrate 132 may include at least one selected from the group consisting of glass, resin, plastic, ceramics and a circuit board. Of course, the embodiments of the present disclosure include but are not limited thereto, and the first substrate and the second substrate can also be made of other suitable materials.

In some examples, planar shapes of the first substrate 131 and the second substrate 132 may be rectangular. Of course, the embodiments of the present disclosure include but are not limited thereto, and the planar shapes of the first substrate and the second substrate can also be other suitable shapes.

In some examples, materials of the first conductive pattern layer 134 and the second conductive pattern layer 135 include metals such as copper, aluminum, gold, silver or their alloys. Of course, the embodiments of the present disclosure include but are not limited thereto, and the materials of the first conductive pattern layer and the second conductive pattern layer can also be conductive nonmetallic materials, such as conductive metal oxides.

In some examples, a thickness of the liquid crystal layer 133 is greater than twice a thickness of the first conductive pattern layer 134 or twice a thickness of the second conductive pattern layer 135, so that the full phase adjustable phase shifter 130A and the first adjustable phase shifter 130C have better performance.

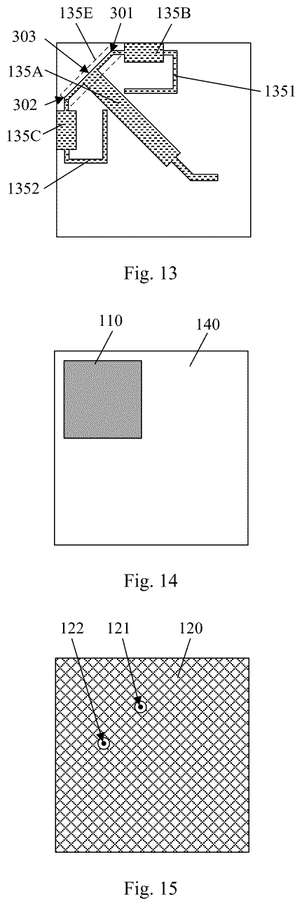

FIG. 12 is a schematic plan view of a first conductive pattern in another liquid crystal antenna array according to an embodiment of the present disclosure; FIG. 13 is a schematic plan view of a second conductive pattern in another liquid crystal antenna array according to an embodiment of the present disclosure.

In some examples, as illustrated by FIGS. 12 and 13, the first conductive pattern 134 includes a first driving electrode 134A, a second driving electrode 134B and a third driving electrode 134C, and the second conductive pattern 135 includes a first common electrode 135A, a second common electrode 135B and a third common electrode 135C; an orthographic projection of the first driving electrode 134A on the liquid crystal layer 133 overlaps with an orthographic projection of the first common electrode 135A on the liquid crystal layer 133, so that the first driving electrode 134A, the first common electrode 135A, and the liquid crystal layer between the first driving electrode 134A and the first common electrode 135A can form the full phase adjustable phase shifter 130A, and a magnitude of the phase modulated by the full phase adjustable phase shifter 130A can be controlled by controlling an electric signal of the first driving electrode 134A. An orthographic projection of the second driving electrode 134B on the liquid crystal layer 133 overlaps with an orthographic projection of the second common electrode 135B on the liquid crystal layer 133, so that the second driving electrode 134B, the second common electrode 135B, and the liquid crystal layer between the second driving electrode 134B and the second common electrode 135B can form the first adjustable phase shifter 130C, and a magnitude of the phase modulated by the first adjustable phase shifter 130C can be controlled by controlling an electric signal of the second driving electrode 134B. An orthographic projection of the third driving electrode 134C on the liquid crystal layer 133 overlaps with an orthographic projection of the third common electrode 135C on the liquid crystal layer 133, so that the third driving electrode 134C, the third common electrode 135C, and the liquid crystal layer between the third driving electrode 134C and the third common electrode 135C can form the second adjustable phase shifter 130D, and a magnitude of the phase modulated by the second adjustable phase shifter 130D can be controlled by controlling an electric signal of the third driving electrode 134C.

In some examples, the liquid crystal layer between the first driving electrode and the first common electrode, the liquid crystal layer between the second driving electrode and the second common electrode and the liquid crystal layer between the third driving electrode and the third common electrode may be separated from each other by barrier structures, so that different liquid crystal materials may be used as needed.

In some examples, as illustrated by FIG. 12, the first conductive pattern layer 134 further includes a first driving line 1341, a second driving line 1342 and a third driving line 1343; the first driving line 1341 is connected with the first driving electrode 134A, the second driving line 1342 is connected with the second driving electrode 134B, and the third driving line 1343 is connected with the third driving electrode 134C. Therefore, driving signals can be respectively applied to the first driving electrode, the second driving electrode and the third driving electrode through the first driving line, the second driving line and the third driving line, so as to respectively control a phase shift amount of the full phase adjustable phase shifter, a phase shift amount of the first adjustable phase shifter and a phase shift amount of the second adjustable phase shifter.

In some examples, as illustrated by FIG. 12, an area of the first driving electrode 134A is larger than an area of the second driving electrode 134B or an area of the third driving electrode 134C, so that an overall area of the first conductive pattern layer can be reduced, which is beneficial to miniaturization of the liquid crystal antenna array. Even, the area of the first driving electrode 134A is larger than the sum of the area of the second driving electrode 134B and the area of the third driving electrode 134C, so that the overall area of the first conductive pattern layer can be effectively reduced, which is beneficial to miniaturization of the liquid crystal antenna array.

In some examples, as illustrated by FIG. 13, the second conductive pattern layer 135 further includes a power division conductive pattern 135E including a first end portion 301, a second end portion 302 and an intermediate portion 303 located between the first end portion 301 and the second end portion 302; the intermediate portion 303 can be used as the input end of the power division structure 130B, so as to be coupled with the output end of the full phase adjustable phase shifter 130A. The first end portion 301 is the first output end of the power division structure 130B, and the second end portion 302 is the second output end of the power division structure 130B.

In some examples, as illustrated by FIG. 13, the second conductive pattern layer 135 further includes a first transmission line 1351 and a second transmission line 1352; the intermediate portion 303 of the power division conductive pattern 135E is coupled with the first common electrode 135A, so as to realize the coupling with the output end of the full phase adjustable phase shifter 130A; first end portion 301 of the power division conductive pattern 135E is connected with the second common electrode 135B, so that the first output end of the power division structure 135 is coupled with the first adjustable phase shifter 130C. The first transmission line 1351 connects the second common electrode 135B with the first coupling structure 121, thereby connecting the output end of the first adjustable phase shifter 130C with the first coupling structure 121; the second transmission line 1352 connects the third common electrode 135C with the second coupling structure 122, thereby connecting the output end of the second adjustable phase shifter 130D with the second coupling structure 122.

In some examples, as illustrated by FIG. 13, the second driving electrode 134B and the third driving electrode 134C are mirror symmetrical about a virtual straight line extending in the extension direction of the first driving electrode 134A, so that the symmetry of the antenna structure can be improved, and the performance of the antenna structure can be further improved.

It is worth noting that although the first conductive pattern layer 134 illustrated by FIG. 12 only includes the first driving electrode 134A, the second driving electrode 134B, the third driving electrode 134C, a first driving line 1341, a second driving line 1342 and the third driving line 1343, the embodiment of the present disclosure includes but is not limited thereto, and other conductive structures may be provided in the first conductive pattern layer as long as independent driving of the first driving electrode, the second driving electrode and the second driving electrode is not affected.

FIG. 14 is a schematic plan view of a radiation patch in another liquid crystal antenna array according to an embodiment of the present disclosure; FIG. 15 is a schematic plan view of a first coupling layer in another liquid crystal antenna array according to an embodiment of the present disclosure. It should be noted that FIG. 14 not only shows the radiation patch, but also shows a third substrate between the radiation patch and the first coupling layer. The third substrate can be used to carry the radiation patch and can also be used to insulating the first coupling layer and the radiation patch from each other.

In some examples, as illustrated by FIGS. 14 and 15, the radiation patch 110 is disposed on the third substrate 140, and the third substrate 130 may be disposed between the radiation patch 110 and the first coupling layer 120 (see FIG. 11).

In some examples, a material of the third substrate 140 may include at least one selected from the group consisting of glass, resin, plastic, ceramics and a circuit board. Of course, the embodiments of the present disclosure include but are not limited thereto, and the third substrate can also be made of other suitable materials.

In some examples, as illustrated by FIG. 14, in order to ensure the polarization function, a planar shape of the radiation patch 110 may adopt a centrally symmetric shape. For example, the shape of the radiation patch 110 is a square with central symmetry. Of course, the embodiments of the present disclosure include but are not limited thereto, and the shape of the radiation patch can also adopt other shapes with central symmetry, such as a circle or a pixel surface. It should be noted that the above-mentioned pixel surface is a square whole composed of a plurality of square arrays or a circular whole composed of a plurality of circular arrays.

In some examples, as illustrated by FIGS. 13 and 15, the first coupling layer 120 may be a conductive layer; the first coupling structure 121 includes a first probe 121 passing through the first coupling layer 120, and the second coupling structure 122 includes a second probe 122 passing through the first coupling layer 120. Therefore, the first coupling structure 121 can couple the output end of the first adjustable phase shifter 130C with the radiation patch 110, and the second coupling structure 122 can couple the output end of the second adjustable phase shifter 130D with the radiation patch 110.

In some examples, as illustrated by FIGS. 13 and 15, the first coupling layer 120 may include two through holes (avoidance holes) corresponding to the first probe 121 and the second probe 122, so that the first probe 121 and the second probe 122 can pass through. It should be noted that an aperture of the through hole is larger than a diameter of the probe to avoid the contact between the probe and the first coupling layer.

It is worth noting that the first coupling structure and the second coupling structure in the antenna structure in the liquid crystal antenna array illustrated by FIGS. 10 and 11 can be the probes illustrated by FIGS. 13 and 15, and can also be the slots illustrated by FIG. 7.

In some examples, as illustrated by FIGS. 10 and 11, each antenna structure 100 further includes a second coupling layer 150 and a receiving structure 160; the second coupling layer 150 includes a third coupling structure 153; the third coupling structure 153 couples the receiving structure 160 with the input end of the full phase adjustable phase shifter 130A, so that each antenna structure can receive an electromagnetic wave signal and input the electromagnetic wave signal to the full phase adjustable phase shifter 130A.

In some examples, as illustrated by FIGS. 10 and 11, each antenna structure 100 further includes a fourth substrate 170 located between the second coupling layer 150 and the receiving structure 160; the fourth substrate 170 can be used to carry the receiving structure and can also be used to insulating the second coupling layer and the receiving structure from each other.

In some examples, a material of the fourth substrate 170 may include at least one selected from the group consisting of glass, resin, plastic, ceramics and a circuit board. Of course, the embodiments of the present disclosure include but are not limited thereto, and the fourth substrate can also be made of other suitable materials.

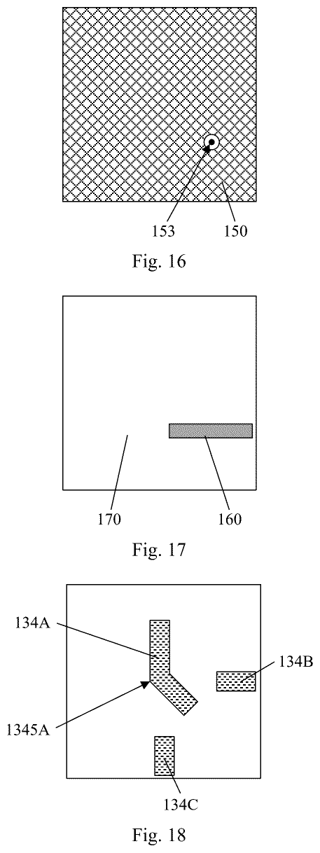

FIG. 16 is a schematic plan view of a second coupling layer in another liquid crystal antenna array according to an embodiment of the present disclosure; FIG. 17 is a schematic plan view of a receiving structure in another liquid crystal antenna array according to an embodiment of the present disclosure.

In some examples, as illustrated by FIG. 16, the third coupling layer 150 is a conductive layer; the third coupling structure 153 includes a third probe 153 passing through the second coupling layer 150, so that the third coupling structure 153 can couple the receiving structure with the input end of the full phase adjustable phase shifter.

In some examples, as illustrated by FIG. 16, the third coupling layer 150 may include a through hole (avoidance hole) corresponding to the third probe 153, so that the third probe 153 can pass through. It should be noted that an aperture of the through hole is larger than a diameter of the probe to avoid the contact between the probe and the third coupling layer.

In some examples, as illustrated by FIG. 17, the receiving structure 160 is a feed line. Of course, the embodiments of the present disclosure include but are not limited thereto, and the receiving structure can also adopt a receiving patch.

It is worth noting that some plan views of the above-mentioned embodiments show specific examples of the plane position relationships among the radiation patch, the full phase adjustable phase shifter, the first adjustable phase shifter, the second adjustable phase shifter and the receiving structure, but the embodiments of the present disclosure include but are not limited to the above-mentioned plane position relationships, and the position of each component can be adjusted or rotated according to the actual layout needs to adjust these plane position relationships. In particular, because the length of the full phase adjustable phase shifter is usually relatively large, it can be bent to further save space.

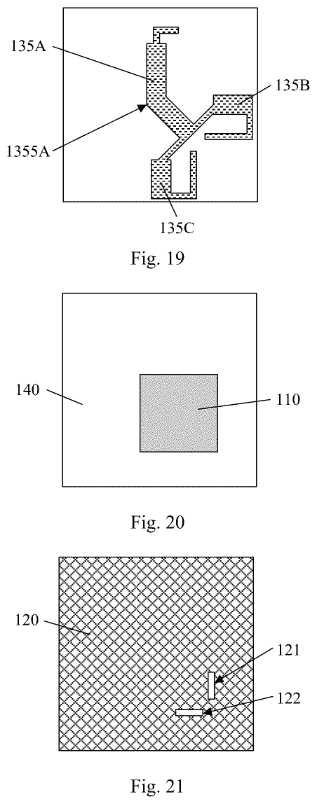

FIG. 18 is a schematic plan view of a first conductive pattern in another liquid crystal antenna array according to an embodiment of the present disclosure; FIG. 19 is a schematic plan view of a second conductive pattern in another liquid crystal antenna array according to an embodiment of the present disclosure.

In some examples, as illustrated by FIGS. 18 and 19, in order to further reduce the area of the antenna structure and optimize the layout, the first driving electrode and the first common electrode with relatively long length can be bent. In this case, the first driving electrode 134A includes a bent portion 1345A, and the first common electrode 135A includes a bent portion 1355A.

FIG. 20 is a schematic plan view of a radiation patch in another liquid crystal antenna array according to an embodiment of the present disclosure; FIG. 21 is a schematic plan view of a first coupling layer in another liquid crystal antenna array according to an embodiment of the present disclosure.

In some examples, as illustrated by FIG. 20, the radiation patch 110 is disposed on the third substrate 140, the planar shape of the radiation patch 110 may adopt a centrally symmetric shape. For example, the shape of the radiation patch 110 is a square with central symmetry. Of course, the embodiments of the present disclosure include but are not limited thereto, and the shape of the radiation patch can also adopt other shapes with central symmetry, such as a circle or a pixel surface.

In some examples, as illustrated by FIG. 21, the first coupling layer 120 may be a conductive layer; the first coupling structure 121 includes a first slot 121 located in the first coupling layer 120, and the second coupling structure 122 includes a second slot 122 located in the first coupling layer 120. Therefore, the first coupling structure 121 can couple the output end of the first adjustable phase shifter 130C with the radiation patch 110, and the second coupling structure 122 can couple the electromagnetic wave output from the second output end of the power division structure 130B with the radiation patch 110.

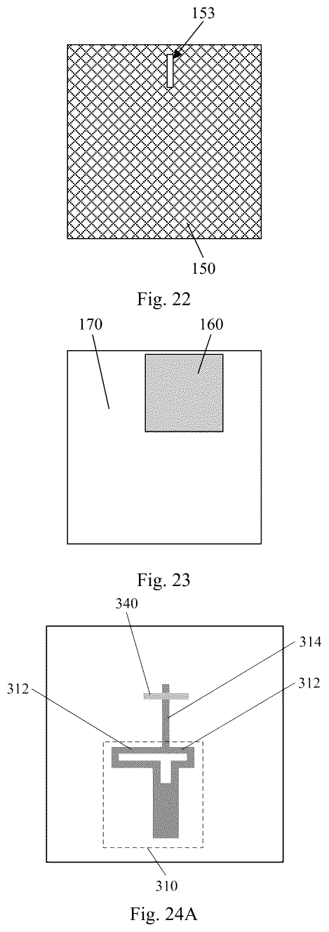

FIG. 22 is a schematic plan view of a second coupling layer in another liquid crystal antenna array according to an embodiment of the present disclosure; FIG. 23 is a schematic plan view of a receiving structure in another liquid crystal antenna array according to an embodiment of the present disclosure.

In some examples, as illustrated by FIG. 22, the third coupling layer 150 is a conductive layer; the third coupling structure 153 includes a third slot 153 located in the second coupling layer 150, so that the third coupling structure 153 can couple the receiving structure with the input end of the full phase adjustable phase shifter.

In some examples, as illustrated by FIG. 23, the receiving structure 160 is a receiving patch, and its planar shape is a square with central symmetry. Of course, the embodiments of the present disclosure include but are not limited thereto, and the receiving patch can also be a circle or pixel surface with central symmetry.

In the above embodiments, the full phase adjustable phase shifter includes any one of a delay linear adjustable phase shifter, a differential linear adjustable phase shifter and a resonant adjustable phase shifter, the first adjustable phase shifter includes any one of a delay linear adjustable phase shifter, a differential linear adjustable phase shifter and a resonant adjustable phase shifter, and the second adjustable phase shifter includes any one of a delay linear adjustable phase shifter, a differential linear adjustable phase shifter and a resonant adjustable phase shifter. In addition, the full phase adjustable phase shifter, the first adjustable phase shifter and the second adjustable phase shifter can adopt the same type of phase shifter, and can also adopt different types of phase shifters.

Hereinafter, according to different types of phase shifters, the coupling modes of the full phase adjustable phase shifter, first adjustable phase shifter and second adjustable phase shifter with the coupling structure are described with reference to the accompanying drawings.

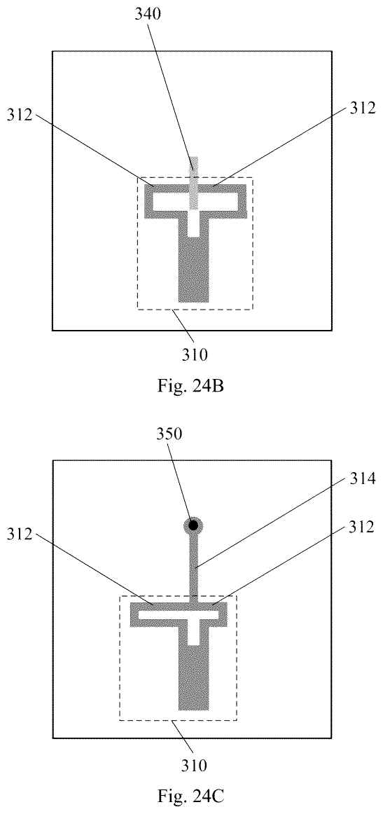

FIG. 24A is a schematic diagram of a coupling mode between a differential linear adjustable phase shifter and a coupling slot according to an embodiment of the present disclosure; FIG. 24B is a schematic diagram of a coupling mode between another differential linear adjustable phase shifter and a coupling slot provided by an embodiment of the present disclosure; FIG. 24C is a schematic diagram of a coupling mode between a differential linear adjustable phase shifter and a probe provided by an embodiment of the present disclosure.

In some examples, as illustrated by FIG. 24A, one end (an output end or an input end) of a differential linear adjustable phase shifter 310 includes two branch lines 312, and ends of the two branch lines 312 are connected to form an annular portion; in this case, a connection line 314 can be arranged to connect with the annular portion, and a coupling slot 340 can be overlapped with the connection line 314, so as to realize coupling one end of the differential linear adjustable phase shifter 310 with the coupling slot 340.

In some examples, as illustrated by FIG. 24B, one end (an output end or an input end) of a differential linear adjustable phase shifter 310 includes two branch lines 312, and ends of the two branch lines 312 are connected to form an annular portion; in this case, a coupling slot 340 can be directly overlapped with the annular portion to realize coupling one end of the differential linear adjustable phase shifter 310 with the coupling slot 340.

In some examples, as illustrated by FIG. 24C, one end (an output end or an input end) of a differential linear adjustable phase shifter 310 includes two branch lines 312, and ends of the two branch lines 312 are connected to form an annular portion; in this case, a connection line 314 can be arranged to connect with the annular portion, and a probe 350 can be arranged in contact with the connection line 314, so as to realize coupling one end of the differential linear adjustable phase shifter 310 with the probe 350.

In some examples, as illustrated by FIG. 24C, the connection line 314 may include a contact portion to be in contact with the probe 350.

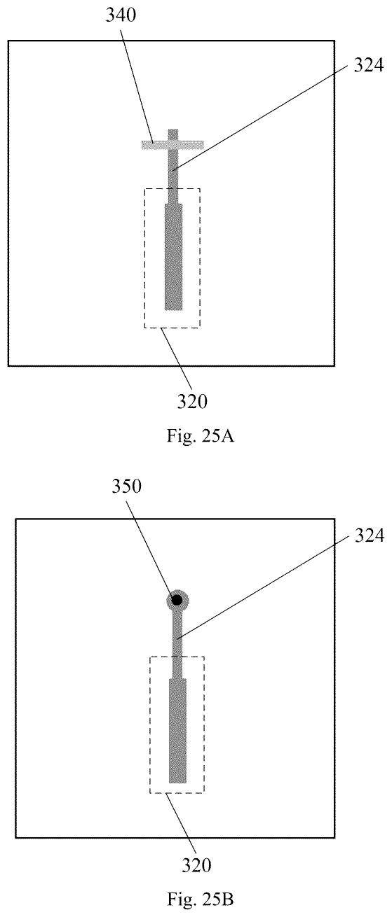

FIG. 25A is a schematic diagram of a coupling mode between a delay linear adjustable phase shifter and a coupling slot according to an embodiment of the present disclosure; FIG. 25B is a schematic diagram of a coupling mode between another delay linear adjustable phase shifter and a probe provided by an embodiment of the present disclosure.

In some examples, as illustrated by FIG. 25A, a connection line 324 may be provided to connect with one end (an output end or an input end) of a delay linear adjustable phase shifter 320, and a coupling slot 340 is overlapped with the connection line 324 to realize coupling one end of the delay linear adjustable phase shifter 320 with the coupling slot 340.

In some examples, as illustrated by FIG. 25B, a connection line 324 may be provided to connect with one end (an output end or an input end) of a delay linear adjustable phase shifter 320, and a probe 350 is overlapped with the connection line 324 to realize coupling one end of the delay linear adjustable phase shifter 320 with the probe 350.

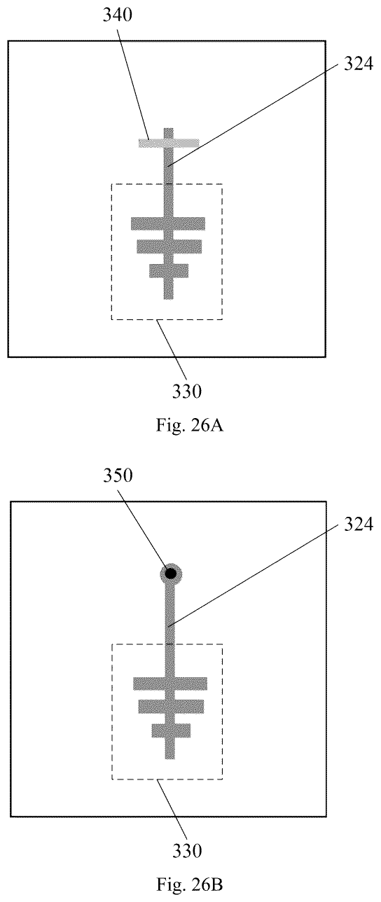

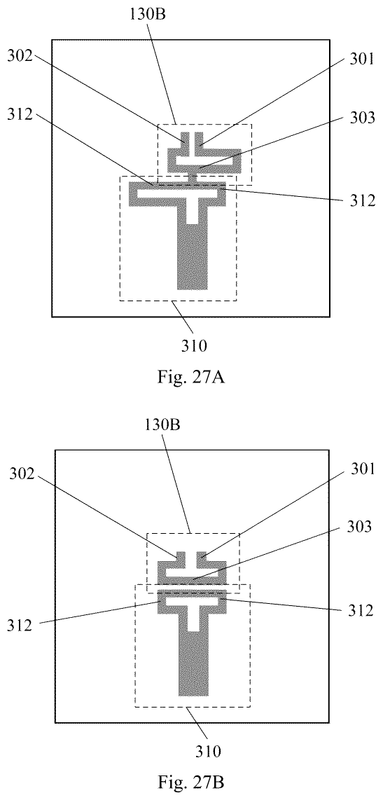

FIG. 26A is a schematic diagram of a coupling mode between a resonant adjustable phase shifter and a coupling slot according to an embodiment of the present disclosure; FIG. 26B is a schematic diagram of a coupling mode between another resonant adjustable phase shifter and a probe provided by an embodiment of the present disclosure.

In some examples, as illustrated by FIG. 26A, a connection line 324 may be provided to connect with one end (an output end or an input end) of a resonant adjustable phase shifter 330, and a coupling slot 340 is overlapped with the connection line 324 to realize coupling one end of the resonant adjustable phase shifter 330 with the coupling slot 340.

In some examples, as illustrated by FIG. 26B, a connection line 324 may be provided to connect with one end (an output end or an input end) of a resonant adjustable phase shifter 330, and a probe 350 is overlapped with the connection line 324 to realize coupling one end of the resonant adjustable phase shifter 330 with the probe 350.

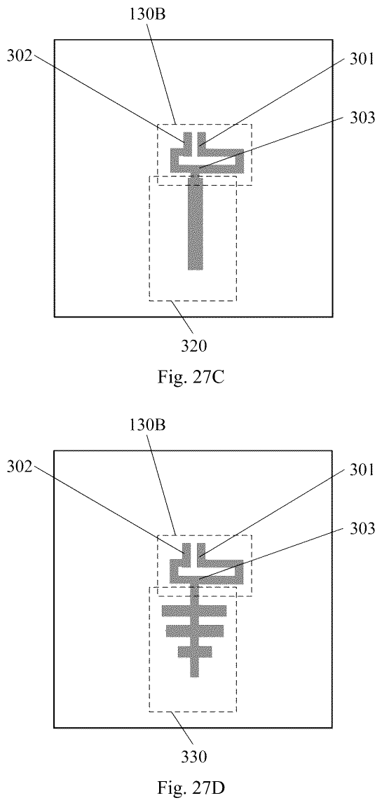

FIG. 27A is a schematic diagram of a coupling mode between a differential linear adjustable phase shifter and a power division structure according to an embodiment of the present disclosure; FIG. 27B is a schematic diagram of a coupling mode between another differential linear adjustable phase shifter and a power division structure provided by an embodiment of the present disclosure; FIG. 27C is a schematic diagram of a coupling mode between a delay linear adjustable phase shifter and a power division structure according to an embodiment of the present disclosure; FIG. 27D is a schematic diagram of a coupling mode between a resonant adjustable phase shifter and a power division structure according to an embodiment of the present disclosure.

In some examples, as illustrated by FIG. 27A, one end (an output end or an input end) of a differential linear adjustable phase shifter 310 includes two branch lines 312, and ends of the two branch lines 312 are connected to form an annular portion; a power division structure 130B includes a first end portion 301, a second end portion 302 and an intermediate portion 303 located between the first end portion 301 and the second end portion 302, the intermediate portion 303 can be used as the input end of the power division structure 130B, the first end portion 301 is the first output end of the power division structure 130B, and the second end portion 302 is the second output end of the power division structure 130B, the intermediate portion 303 of the power division structure 130B is connected with the annular portion of the differential linear adjustable phase shifter 310, thereby realizing the coupling between the differential linear adjustable phase shifter and the power division structure.

In some examples, as illustrated by FIG. 27B, one end (an output end or an input end) of a differential linear adjustable phase shifter 310 includes two branch lines 312, and ends of the two branch lines 312 are connected to form an annular portion; a power division structure 130B includes a first end portion 301, a second end portion 302 and an intermediate portion 303 located between the first end portion 301 and the second end portion 302, the intermediate portion 303 can be used as the input end of the power division structure 130B, the first end portion 301 is the first output end of the power division structure 130B, and the second end portion 302 is the second output end of the power division structure 130B, the intermediate portion 303 of the power division structure 130B is disposed opposite to and spaced from the annular portion of the differential linear adjustable phase shifter 310, thereby realizing the coupling between the differential linear adjustable phase shifter and the power division structure.

In some examples, as illustrated by FIG. 27C, a power division structure 130B includes a first end portion 301, a second end portion 302 and an intermediate portion 303 located between the first end portion 301 and the second end portion 302, the intermediate portion 303 can be used as the input end of the power division structure 130B, the first end portion 301 is the first output end of the power division structure 130B, and the second end portion 302 is the second output end of the power division structure 130B, the intermediate portion 303 of the power division structure 130B is connected with one end of the delay linear adjustable phase shifter 320, thereby realizing the coupling between the delay linear adjustable phase shifter and the power division structure.

In some examples, as illustrated by FIG. 27D, a power division structure 130B includes a first end portion 301, a second end portion 302 and an intermediate portion 303 located between the first end portion 301 and the second end portion 302, the intermediate portion 303 can be used as the input end of the power division structure 130B, the first end portion 301 is the first output end of the power division structure 130B, and the second end portion 302 is the second output end of the power division structure 130B, the intermediate portion 303 of the power division structure 130B is connected with one end of the resonant adjustable phase shifter 330, thereby realizing the coupling between the resonant adjustable phase shifter and the power division structure.

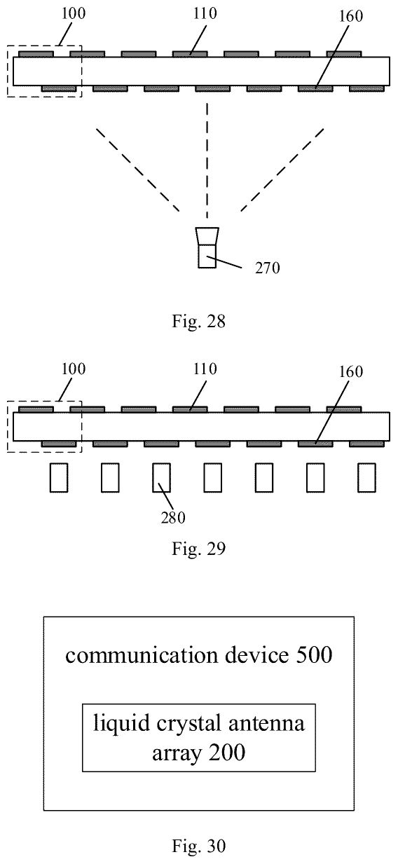

FIG. 28 is a schematic diagram of another liquid crystal antenna array provided by an embodiment of the present disclosure; FIG. 29 is a schematic diagram of another liquid crystal antenna array provided by an embodiment of the present disclosure.

In some examples, as illustrated by FIG. 28, the liquid crystal antenna array 200 further includes a feed structure 270, which is arranged at a side of the plurality of receiving structures 160 of the plurality of antenna structures 100 away from the plurality of radiation patches 110, so as to irradiate the plurality of receiving structures 160.

For example, the feed structure 270 can be a feed horn. Of course, embodiments of the present disclosure include but are not limited thereto.

In some examples, as illustrated by FIG. 29, the liquid crystal antenna array 200 further includes a plurality of waveguides 280, which are arranged at a side of the plurality of receiving structures 160 of the plurality of antenna structures 100 away from the plurality of radiation patches 110, and are arranged in one-to-one correspondence with the plurality of receiving structures 160 of the plurality of antenna structures 100, so that the plurality of receiving structures 160 are fed by near-field waveguide coupling.

In some examples, as illustrated by FIG. 28 and FIG. 29, the receiving structure 160 and the radiation patch 110 of two adjacent antenna structures 100 may overlap each other to further optimize the layout and reduce the area of the liquid crystal antenna array.

An embodiment of the present disclosure further provides a communication device. FIG. 30 is a schematic diagram of a communication device provided by an embodiment of the present disclosure. As illustrated by FIG. 30, the communication device 500 includes any of the above-mentioned liquid crystal antenna arrays 200. Therefore, the communication device can perform beam scanning through the liquid crystal antenna array, and can also perform polarization adjustment or polarization reconstruction through the liquid crystal antenna array, so as to meet different scenes requiring different polarization characteristics, thus having high communication performance. Moreover, because the liquid crystal antenna array is relatively small in size, miniaturization of the communication device is also utilized.

For example, the communication device can be an electronic product with communication function such as a mobile phone, a navigator, a notebook computer, etc.

The present disclosure further provides a driving method of the liquid crystal antenna array, which includes: phase modulating an electromagnetic wave input into an antenna structure through a full phase adjustable phase shifter; dividing the phase-modulated electromagnetic wave into a first electromagnetic wave signal and a second electromagnetic wave signal through a power division structure; phase modulating the first electromagnetic wave signal through a first adjustable phase shifter, so that the first electromagnetic wave signal and the second electromagnetic wave signal have a phase difference; and using a radiation patch to polarize the first electromagnetic wave signal and the second electromagnetic wave signal.

For example, in the case that the first adjustable phase shifter can phase modulate the first electromagnetic wave signal, so that the first electromagnetic wave signal and the second electromagnetic wave signal have the phase difference of 90 degrees, the circularly polarized wave can be formed in the radiation patch and transmitted through the radiation patch.

For example, in the case that the first adjustable phase shifter can phase modulate the first electromagnetic wave signal, so that the first electromagnetic wave signal and the second electromagnetic wave signal have the phase difference of 0 degree, the linearly polarized wave can be formed in the radiation patch and transmitted through the radiation patch.

For example, in the case that the first adjustable phase shifter can phase modulate the first electromagnetic wave signal, so that the first electromagnetic wave signal and the second electromagnetic wave signal have the phase difference of more than 0 degree and less than 90 degrees, the elliptically polarized wave can be formed in the radiation patch and transmitted through the radiation patch.

In some examples, in the case that the antenna structure in the liquid crystal antenna array includes a second adjustable phase shifter, the driving method includes: phase modulating an electromagnetic wave input to the antenna structure through a full phase adjustable phase shifter; dividing the phase-modulated electromagnetic wave into a first electromagnetic wave signal and a second electromagnetic wave signal through a power division structure; phase modulating the first electromagnetic wave signal and the second electromagnetic wave signal through a first adjustable phase shifter and a second adjustable phase shifter respectively, so that the first electromagnetic wave signal and the second electromagnetic wave signal have a phase difference; and using a radiation patch to polarize the first electromagnetic wave signal and the second electromagnetic wave signal.

For example, in the case that the first adjustable phase shifter and the second adjustable phase shifter can respectively phase modulate the first electromagnetic wave signal and the second electromagnetic wave signal, so that the first electromagnetic wave signal and the second electromagnetic wave signal have the phase difference of 90 degrees, the circularly polarized wave can be formed in the radiation patch and transmitted through the radiation patch.

For example, in the case that the first adjustable phase shifter and the second adjustable phase shifter can respectively phase modulate the first electromagnetic wave signal and the second electromagnetic wave signal, so that the first electromagnetic wave signal and the second electromagnetic wave signal have the phase difference of 0 degree, the linearly polarized wave can be formed in the radiation patch and transmitted through the radiation patch.

For example, in the case that the first adjustable phase shifter and the second adjustable phase shifter can respectively phase modulate the first electromagnetic wave signal and the second electromagnetic wave signal, so that the first electromagnetic wave signal and the second electromagnetic wave signal have the phase difference of more than 0 degree and less than 90 degrees, the elliptically polarized wave can be formed in the radiation patch and transmitted through the radiation patch.

The following points need to be explained:
(1) In the drawings of the embodiment of the present disclosure, only the structure related to the embodiment of the present disclosure is involved, and other structures can refer to the general design.
(2) Features in the same embodiment and different embodiments of the present disclosure can be combined with each other without conflict.

The above is only the specific embodiment of the present disclosure, but the protection scope of the present disclosure is not limited thereto. Any person familiar with the technical field can easily think of changes or substitutions within the technical scope disclosed in this disclosure, and they should be included in the protection scope of this disclosure. Therefore, the scope of protection of this disclosure should be based on the scope of protection of the claims.

1. A liquid crystal antenna array, comprising a plurality of antenna structures arranged in an array, wherein each of the plurality of antenna structure comprises:
a phase shifter layer, comprising a full phase adjustable phase shifter, a power division structure and at least one adjustable phase shifter;
a radiation patch; and
a first coupling layer,
wherein the power division structure comprises an input end, a first output end and a second output end, an output end of the full phase adjustable phase shifter is coupled with the input end of the power division structure, the at least one adjustable phase shifter comprises a first adjustable phase shifter, the first adjustable phase shifter is coupled with the first output end of the power division structure,
the first coupling layer comprises a first coupling structure and a second coupling structure, the first coupling structure couples an output end of the first adjustable phase shifter with the radiation patch, and the second coupling structure couples an electromagnetic wave output from the second output end of the power division structure to the radiation patch, a first connection line between a center of the first coupling structure and a center of the radiation patch and a second connection line between a center of the second coupling structure and the center of the radiation patch are perpendicular to each other,
a phase adjustment range of the first adjustable phase shifter is smaller than a phase adjustment range of the full phase adjustable phase shifter, an area of the first adjustable phase shifter is smaller than an area of the full phase adjustable phase shifter.

2. The liquid crystal antenna array according to claim 1, wherein the phase adjustment range of the first adjustable phase shifter is in a range from 0 to 90 degrees.

3. The liquid crystal antenna array according to claim 1, wherein the full phase adjustable phase shifter is configured to adjust a phase of an electromagnetic wave input to each of the plurality of antenna structure, and the power division structure and the first adjustable phase shifter are configured to adjust a polarization of the electromagnetic wave input to each of the plurality of antenna structure.

4. The liquid crystal antenna array according to claim 1, wherein in at least one of the plurality of antenna structure, the at least one adjustable phase shifter further comprises a second adjustable phase shifter, the second adjustable phase shifter is coupled with the second output end of the power division structure, and the second coupling structure couples an output end of the second adjustable phase shifter with the radiation patch, so as to couple the electromagnetic wave output from the second output end of the power division structure to the radiation patch,
the phase adjustment range of the first adjustable phase shifter is smaller than the phase adjustment range of the full phase adjustable phase shifter, and the area of the first adjustable phase shifter is smaller than the area of the full phase adjustable phase shifter, a phase adjustment range of the second adjustable phase shifter is smaller than the phase adjustment range of the full phase adjustable phase shifter, and an area of the second adjustable phase shifter is smaller than the area of the full phase adjustable phase shifter.

5. The liquid crystal antenna array according to claim 4, wherein the phase adjustment range of the first adjustable phase shifter is in a range from 0 to 90 degrees, the phase adjustment range of the second adjustable phase shifter is in a range from 0 to 90 degrees.

6. The liquid crystal antenna array according to claim 4, wherein the full phase adjustable phase shifter is configured to adjust a phase of an electromagnetic wave input to each of the plurality of antenna structure, and the power division structure, the first adjustable phase shifter and the second adjustable phase shifter are configured to adjust a polarization of an electromagnetic wave input to each of the plurality of antenna structure.

7. The liquid crystal antenna array according to claim 1, wherein the phase shifter layer comprises:
a first substrate;
a second substrate, disposed opposite to and spaced from the first substrate;
a liquid crystal layer, located between the first substrate and the second substrate;
a first conductive pattern layer; and
a second conductive pattern layer,
wherein the first conductive pattern layer is located at a side of the first substrate close to the liquid crystal layer, and the second conductive pattern layer is located at a side of the second substrate close to the liquid crystal layer,
or, the first conductive pattern layer is located at a side of the second substrate close to the liquid crystal layer, and the second conductive pattern layer is located at a side of the first substrate close to the liquid crystal layer.

8. The liquid crystal antenna array according to claim 7, wherein the first conductive pattern comprises a first driving electrode and a second driving electrode, and the second conductive pattern comprises a first common electrode and a second common electrode;
an orthographic projection of the first driving electrode on the liquid crystal layer overlaps with an orthographic projection of the first common electrode on the liquid crystal layer, so as to form the full phase adjustable phase shifter, an orthographic projection of the second driving electrode on the liquid crystal layer overlaps with an orthographic projection of the second common electrode on the liquid crystal layer, so as to form the first adjustable phase shifter,
an area of the first driving electrode is larger than an area of the second driving electrode.

9. (canceled)

10. The liquid crystal antenna array according to claim 8, wherein the second conductive pattern layer further comprises a power division conductive pattern comprising a first end portion, a second end portion and an intermediate portion located between the first end portion and the second end portion;
the intermediate portion is the input end of the power division structure, the first end portion is the first output end of the power division structure, and the second end portion is the second output end of the power division structure.

11. The liquid crystal antenna array according to claim 10, wherein the second conductive pattern layer further comprises a first transmission line and a second transmission line;
the intermediate portion of the power division conductive pattern is coupled with the first common electrode, first end portion of the power division conductive pattern is connected with the second common electrode, the first transmission line connects the second common electrode with the first coupling structure, the second transmission line connects the second end portion of the power division conductive pattern with the second coupling structure.

12. The liquid crystal antenna array according to claim 8, wherein the first driving electrode comprises a bent portion, and the first common electrode comprises a bent portion.

13. (canceled)

14. The liquid crystal antenna array according to claim 4, wherein the phase shifter layer comprises:
a first substrate;
a second substrate, disposed opposite to and spaced from the first substrate;
a liquid crystal layer, located between the first substrate and the second substrate;
a first conductive pattern layer; and
a second conductive pattern layer,
wherein the first conductive pattern layer is located at a side of the first substrate close to the liquid crystal layer, and the second conductive pattern layer is located at a side of the second substrate close to the liquid crystal layer,
or, the first conductive pattern layer is located at a side of the second substrate close to the liquid crystal layer, and the second conductive pattern layer is located at a side of the first substrate close to the liquid crystal layer.

15. The liquid crystal antenna array according to claim 14, wherein the first conductive pattern comprises a first driving electrode, a second driving electrode and a third driving electrode, and the second conductive pattern comprises a first common electrode, a second common electrode and a third common electrode;
an orthographic projection of the first driving electrode on the liquid crystal layer overlaps with an orthographic projection of the first common electrode on the liquid crystal layer, so as to form the full phase adjustable phase shifter, an orthographic projection of the second driving electrode on the liquid crystal layer overlaps with an orthographic projection of the second common electrode on the liquid crystal layer, so as to form the first adjustable phase shifter, an orthographic projection of the third driving electrode on the liquid crystal layer overlaps with an orthographic projection of the third common electrode on the liquid crystal layer, so as to form the second adjustable phase shifter.
the second driving electrode and the third driving electrode are mirror symmetrical about a virtual straight line extending in an extension direction of the first driving electrode.

16. (canceled)

17. The liquid crystal antenna array according to claim 1, wherein the full phase adjustable phase shifter comprises any one of a delay linear adjustable phase shifter, a differential linear adjustable phase shifter and a resonant adjustable phase shifter, and the first adjustable phase shifter comprises any one of a delay linear adjustable phase shifter, a differential linear adjustable phase shifter and a resonant adjustable phase shifter.

18. The liquid crystal antenna array according to claim 1, wherein the first coupling structure comprises a first slot located in the first coupling layer, and the second coupling structure comprises a second slot located in the first coupling layer,
or, the first coupling structure comprises a first probe passing through the first coupling layer, and the second coupling structure comprises a second probe passing through the first coupling layer.

19. The liquid crystal antenna array according to claim 1, wherein each of the plurality of antenna structure further comprises:
a second coupling layer, comprising a third coupling structure; and
a receiving structure;
wherein, the third coupling structure couples the receiving structure with an input end of the full phase adjustable phase shifter.

20. The liquid crystal antenna array according to claim 19, wherein the third coupling structure comprises a third slot located in the second coupling layer or a third probe passing through the second coupling layer.

21. The liquid crystal antenna array according to claim 19, wherein the receiving structure comprises a receiving patch or a feed line.

22. The liquid crystal antenna array according to claim 19, further comprising:
a plurality of waveguides, arranged in one-to-one correspondence with the plurality of receiving structures of the plurality of antenna structures.

23. A communication device, comprising the liquid crystal antenna array according to claim 1.
